(19) United States
(12) Patent Application Publication
(10) Pub. No.: US 2022/0046177 A1
(43) Pub. Date: Feb. 10, 2022

(54) CONTROL DEVICE, CAMERA DEVICE, MOVABLE OBJECT, CONTROL METHOD, AND PROGRAM

(71) Applicant: SZ DJI TECHNOLOGY CO., LTD., Shenzhen (CN)

(72) Inventors: Kenichi HONJO, Tokyo (JP); Yoshinori NAGAYAMA, Tokyo (JP)

(21) Appl. No.: 17/506,426

(22) Filed: Oct. 20, 2021

Related U.S. Application Data
(63) Continuation of application No. PCT/CN2020/083101, filed on Apr. 3, 2020.

(30) Foreign Application Priority Data
Apr. 23, 2019 (JP) 2019-082336

(51) Int. Cl. H04N 5/232; H04N 5/225; G01S 17/10

(52) U.S. Cl. CPC H04N 5/232121; G01S 17/10; H04N 5/232123; H04N 5/2258

(57) ABSTRACT

A control device includes a circuit configured to determine, from a plurality of measured distances measured by a ranging sensor of a camera device, a subject distance from the camera device to a subject on a lens optical axis of the camera device based on the plurality of measured distances, an axis distance between the lens optical axis of the camera device and a lens optical axis of the ranging sensor, and an angle of view of the ranging sensor.

### CROSS-REFERENCE TO RELATED APPLICATIONS

This application is a continuation of International Application No. PCT/CN2020/083101, filed Apr. 3, 2020, which claims priority to Japanese Application No. 2019-082336, filed Apr. 23, 2019, the entire contents of both of which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a control device, a camera device, a movable object, a control method, and a program.

### BACKGROUND

Based on a comparison result between various distance compensation TOF pixels and various imaging pixels corresponding to the various distance compensation TOF pixels, various distance pixels corresponding to the distance compensation TOF pixels are detected as error pixels for the various distance compensation TOF pixels whose brightness differences with the various imaging pixels are greater than or equal to a threshold value.
Patent Document 1: Japanese Patent Publication No. 2014-70936.

### SUMMARY

In accordance with the disclosure, there is provided a control device including a circuit configured to determine, from a plurality of measured distances measured by a ranging sensor of a camera device, a subject distance from the camera device to a subject on a lens optical axis of the camera device based on the plurality of measured distances, an axis distance between the lens optical axis of the camera device and a lens optical axis of the ranging sensor, and an angle of view of the ranging sensor

Also in accordance with the disclosure, there is provided a camera device including a ranging sensor including a first image sensor configured to perform distance measurement in a plurality of regions, a second image sensor configured to shoot a subject on a lens optical axis of the camera device, and a control device including a circuit configured to determine, from a plurality of measured distances measured by the ranging sensor, a subject distance from the camera device to the subject based on: the plurality of measured distances, an axis distance between the lens optical axis of the camera device and a lens optical axis of the ranging sensor, and an angle of view of the ranging sensor.

Also in accordance with the disclosure, there is provided a movable object including a camera device including a ranging sensor including a first image sensor configured to perform distance measurement in a plurality of regions, a second image sensor configured to shoot a subject on a lens optical axis of the camera device, and a control device including a circuit configured to determine, from a plurality of measured distances measured by the ranging sensor, a subject distance from the camera device to the subject based on: the plurality of measured distances, an axis distance between the lens optical axis of the camera device and a lens optical axis of the ranging sensor, and an angle of view of the ranging sensor.

Also in accordance with the disclosure, there is provided a control method including determining, from a plurality of measured distances measured by a ranging sensor of a camera device, a subject distance from the camera device to a subject on a lens optical axis of the camera device based on the plurality of measured distances, an axis distance between the lens optical axis of the camera device and a lens optical axis of the ranging sensor, and an angle of view of the ranging sensor.

### BRIEF DESCRIPTION OF THE DRAWINGS

FIG. 1 is an external perspective view of a camera system.

FIG. 2 is a block diagram of a camera system.

FIG. 3 is a diagram showing an example of a positional relationship between a lens optical axis of a camera device and a lens optical axis of a TOF sensor.

FIG. 4 is a flow chart showing an example of a focus control process of a camera controller.

FIG. 5 is a diagram showing an example of a curve representing a relationship between a cost and a lens position.

FIG. 6 is a diagram showing an example of a process of calculating a distance to an object based on a cost.

FIG. 7 is a diagram showing a relationship among an object position, a lens position, and a focal length.

FIG. 8A is a diagram showing a movement direction of a focus lens.

FIG. 8B is a diagram showing a movement direction of a focus lens.

FIG. 9 is a flow chart showing another example of a focus control process of a camera controller.

FIG. 10 is an external perspective view showing another aspect of a camera system.

FIG. 11 is a diagram showing an example of appearance of an unmanned aerial vehicle and a remote operation device.

FIG. 12 is a diagram showing an example of hardware configuration.

### DETAILED DESCRIPTION OF THE EMBODIMENTS

The present disclosure will be described through embodiments of the disclosure, but the following embodiments do not limit the disclosure according to the claims. In addition, all the feature combinations described in the embodiments are not necessarily required for a solution of the disclosure. It is obvious to those of ordinary skill in the art that various changes or improvements can be made to the following embodiments. It is obvious from the description of the claims that all such changes or improvements can be included within the technical scope of the present disclosure.

Various embodiments of the present disclosure can be described with reference to flowcharts and block diagrams, where a block can represent (1) a stage of a process of performing an operation or (2) a “unit” of a device that performs an operation. The designated stage and “unit” can be implemented by programmable circuit and/or processor. Dedicated circuit may include a digital and/or analog hardware circuit. An integrated circuit (IC) and/or a discrete circuit may be included. The programmable circuit may include a reconfigurable hardware circuit. The reconfigurable hardware circuit can include logical AND, logical OR, logical exclusive OR, logical NAND, logical NOR and other logical operations, flip-flop, register, field programmable gate array (FPGA), programmable logic array (PLA) and other memory units.

A computer readable medium may include any tangible device that can store instructions for execution by a suitable device. As a result, the computer readable medium with instructions stored thereon includes a product including instructions that can be executed to create means for performing operations specified in the flowchart or block diagram. Examples of the computer readable media include an electronic storage media, a magnetic storage media, an optical storage media, an electromagnetic storage media, a semiconductor storage media, etc. More specific examples of the computer readable medium include a Floppy® disk, a soft disk, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disc (DVD), a Blu-ray® disc, a memory stick, an integrated circuit card, etc.

Computer readable instructions may include any one of source code or object code described in any combination of one or more programming languages. The source code or object code includes conventional procedural programming languages. The conventional procedural programming languages can be assembly instructions, instruction set architecture (ISA) instructions, machine instructions, machine-related instructions, microcode, firmware instructions, status setting data, or object-oriented programming languages such as Smalltalk, JAVA, C++ and “C” programming language or similar programming languages. The computer readable instructions may be provided to a processor or programmable circuit of a general purpose computer, a special purpose computer, or another programmable data processing device locally or via a wide area network (WAN) such as a local area network (LAN) or internet. The processor or programmable circuit can execute the computer readable instructions to create means for performing the operations specified in the flowchart or block diagram. Examples of the processor include a computer processor, a processing unit, a microprocessor, a digital signal processor, a controller, a microcontroller, etc.

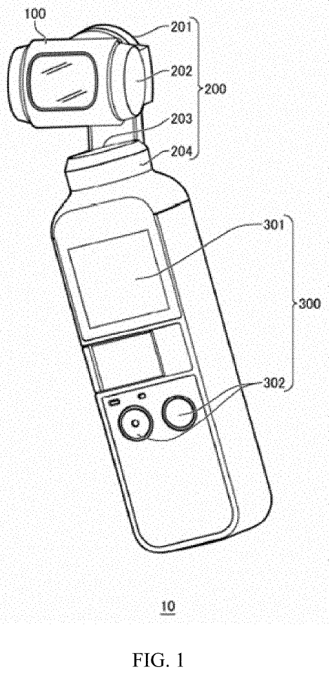

FIG. 1 is a diagram showing an example of an external perspective view of a camera system 10 according to the present disclosure. The camera system 10 includes a camera device 100, a support mechanism 200, and a holding member 300. The support mechanism 200 uses actuators to rotatably support the camera device 100 around a roll axis, a pitch axis, and a yaw axis, respectively. The support mechanism 200 can change or maintain attitude of the camera device 100 by causing the camera device 100 to rotate around at least one of the roll axis, the pitch axis, or the yaw axis. The support mechanism 200 includes a roll axis driver 201, a pitch axis driver 202, and a yaw axis driver 203. The support mechanism 200 also includes a base 204 that secures the yaw axis driver 203. The holding member 300 is fixed to the base 204, and includes an operation interface 301 and a display 302. The camera device 100 is fixed to the pitch axis driver 202.

The operation interface 301 receives instructions for operating the camera device 100 and the support mechanism 200 from a user. The operation interface 301 may include a shutter/video button instructing the camera device 100 to take a picture or record a video. The operation interface 301 may include a power/function key button instructing to turn on or off power of the camera system 10, and to switch a static shooting mode or a dynamic shooting mode of the camera device 100.

The display 302 can display an image captured by the camera device 100, and can display a menu screen for operating the camera device 100 and the support mechanism 200. The display 302 may be a touch panel display that receives the instructions for operating the camera device 100 and the support mechanism 200.

The user holds the holding member 300 to take a static image or a dynamic image through the camera device 100.

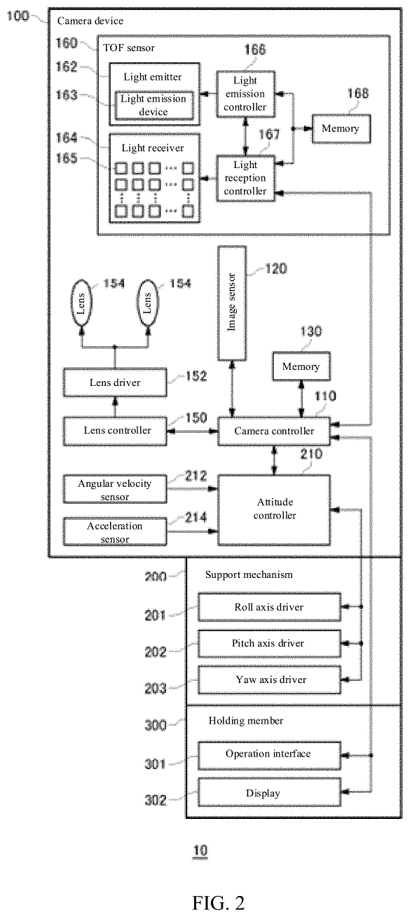

FIG. 2 is a block diagram of the camera system 10. The camera device 100 includes a camera controller 110, an image sensor 120, a memory 130, a lens controller 150, a lens driver 152, a plurality of lenses 154, and a time-of-flight (TOF) sensor 160.

The image sensor 120 may include charge-coupled device (CCD) or complementary metal-oxide-semiconductor (CMOS) device, and is an example of a second image sensor for shooting. The image sensor 120 outputs image data of an optical image imaged by the plurality of lenses 154 to the camera controller 110. The camera controller 110 may include a microprocessor such as a central processing unit (CPU) or a micro processing unit (MPU), a microcontroller such as a micro controlling unit (MCU), etc.

The camera controller 110 follows operation instructions of the holding member 300 to the camera device 100, and performs a demosaicing process on image signals output from the image sensor 120, thereby generating the image data. The camera controller 110 stores the image data in the memory 130, and controls the TOF sensor 160. The camera controller 110 is an example of a circuit. The TOF sensor 160 is a time-of-flight sensor that measures a distance to an object. The camera device 100 adjusts position of a focus lens based on the distance measured by the TOF sensor 160, thereby performing a focus control.

The memory 130 may be a computer readable storage medium, which may include at least one of flash memory such as a static random-access memory (SRAM), a dynamic random-access memory (DRAM), an erasable programmable read-only memory (EPROM), an electrically erasable programmable read-only memory (EEPROM), or a universal serial bus (USB) memory. The memory 130 stores programs needed for the camera controller 110 to control the image sensor 120, etc. The memory 130 may be provided inside a housing of the camera device 100. The holding member 300 may include another memory for storing the image data captured by the camera device 100, and may include a slot through which the memory can be detached from the housing of the holding member 300.

The plurality of lenses 154 can function as a zoom lens, a varifocal lens, and a focus lens. At least some or all of the plurality of lenses 154 are configured to be movable along an optical axis. The lens controller 150 drives the lens driver 152 to move one or more lenses 154 in an optical axis direction according to a lens control instruction from the camera controller 110. The lens control instruction is, for example, a zoom control instruction and a focus control instruction. The lens driver 152 may include a voice coil motor (VCM) that moves at least some or all of the plurality of lenses 154 in the optical axis direction. The lens driver 152 may include a motor such as a direct-current (DC) motor, a coreless motor, or an ultrasonic motor. The lens driver 152 can transmit power from the motor to at least some or all of the plurality of lenses 154 via a mechanism component such as a cam ring, a guide shaft, etc., so that at least some or all of the plurality of lenses 154 can move along the optical axis.

The camera device 100 also includes an attitude controller 210, an angular velocity sensor 212, and an acceleration sensor 214. The angular velocity sensor 212 detects angular velocity of the camera device 100, and detects angular velocity of the roll axis, the pitch axis, and the yaw axis around the camera device 100, respectively. The attitude controller 210 obtains angular velocity information related to the angular velocity of the camera device 100 from the angular velocity sensor 212, and the angular velocity information may indicate the angular velocity of the roll axis, the pitch axis, and the yaw axis around the camera device 100, respectively. The attitude controller 210 obtains acceleration information related to acceleration of the camera device 100 from the acceleration sensor 214, and the acceleration information may indicate acceleration in respective directions of the roll axis, the pitch axis, and the yaw axis of the camera device 100.

The angular velocity sensor 212 and the acceleration sensor 214 may be provided inside the housing that houses the image sensor 120, the lens 154, etc. In some embodiments, a configuration in which the camera device 100 and the support mechanism 200 are integrated is described. In some other embodiments, the support mechanism 200 may include a pedestal that detachably secures the camera device 100, in which case, the angular velocity sensor 212 and the acceleration sensor 214 may be provided outside the housing of the camera device 100, such as the pedestal.

The attitude controller 210 controls the support mechanism 200 to maintain or change the attitude of the camera device 100 based on the angular velocity information and the acceleration information. The attitude controller 210 controls the support mechanism 200 to maintain or change the attitude of the camera device 100 in accordance with an operation mode of the support mechanism 200 for controlling the attitude of the camera device.

The operation modes include the following modes: at least one of the roll axis driver 201, the pitch axis driver 202, or the yaw axis driver 203 of the support mechanism 200 is operated so that attitude change of the camera device 100 follows attitude change of the base 204 of the support mechanism 200; each of the roll axis driver 201, the pitch axis driver 202, and the yaw axis driver 203 of the support mechanism 200 is operated separately so that the attitude change of the camera device 100 follows the attitude change of the base 204 of the support mechanism 200; each of the pitch axis driver 202 and the yaw axis driver 203 of the support mechanism 200 is operated separately so that the attitude change of the camera device 100 follows the attitude change of the base 204 of the support mechanism 200; only the yaw axis driver 203 of the support mechanism 200 is operated so that the attitude change of the camera device 100 follows the attitude change of the base 204 of the support mechanism 200.

The operation modes may include the following modes: an FPV (First Person View) mode in which the support mechanism 200 is operated so that the attitude change of the camera device 100 follows the attitude change of the base 204 of the support mechanism 200; a fixed mode in which the support mechanism 200 is operated to maintain the attitude of the camera device 100.

The FPV mode is a mode in which at least one of the roll axis driver 201, the pitch axis driver 202, or the yaw axis driver 203 of the support mechanism 200 is operated so that the attitude change of the camera device 100 follows the attitude change of the base 204 of the support mechanism 200. The fixed mode is a mode in which at least one of the roll axis driver 201, the pitch axis driver 202, or the yaw axis driver 203 is operated to maintain current attitude of the camera device 100.

The TOF sensor 160 includes a light emitter 162, a light receiver 164, a light emission controller 166, a light reception controller 167, and a memory 168. The TOF sensor 160 is an example of a ranging sensor.

The light emitter 162 includes at least one light emission device 163. The light emission device 163 is a device that repeatedly emits a high-speed modulated pulsed light such as a light-emitting device (LED) or a laser, and the light emission device 163 may emit an infrared pulse light. The light emission controller 166 controls light emission of the light emission device 163, and can control pulse width of the pulsed light emitted by the light emission device 163.

The light receiver 164 includes a plurality of light reception devices 165 that measure distance to each of associated subjects in a plurality of regions. The light receiver 164 is an example of a first image sensor for ranging. The plurality of light reception devices 165 respectively correspond to the plurality of regions. The light reception device 165 repeatedly receives reflected light of the pulsed light from the object. The light reception controller 167 controls light reception of the light reception device 165, and measures the distance to the each of the associated subjects in the plurality of regions based on amount of the reflected light repeatedly received by the light reception device 165 during a predetermined light reception period. The light reception controller 167 can measure the distance to the subject by determining a phase difference between the pulsed light and the reflected light based on the amount of the reflected light repeatedly received by the light reception device 165 during the predetermined light reception period.

The memory 168 may be a computer readable storage medium, which may include at least one of an SRAM, a DRAM, an EPROM, or an EEPROM. The memory 168 stores a program necessary for the light emission controller 166 to control the light emitter 162, a program necessary for the light reception controller 167 to control the light receiver 164, etc.

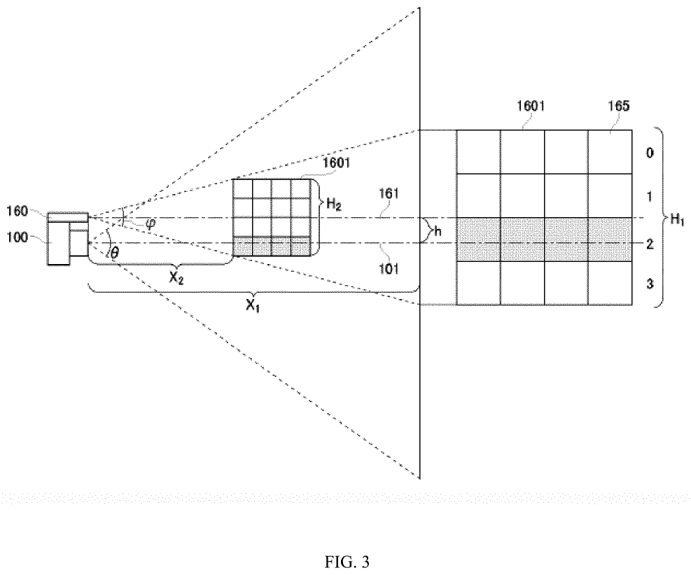

In the camera system 10 configured as described above, a lens optical axis of the camera device 100 and a lens optical axis of the TOF sensor 160 are physically staggered. For example, as shown in FIG. 3, although a lens optical axis 101 of the camera device 100 and a lens optical axis 161 of the TOF sensor 160 are parallel, the lens optical axis 101 and the lens optical axis 161 are spaced apart by a distance h. The lens optical axis 101 is an optical axis of a lens system including the lens 154 that images light on a light reception surface of the image sensor 120 of the camera device 100. The lens optical axis 161 is an optical axis of a lens system that images light on a light receiver 164, i.e., a light reception surface of the TOF sensor 160. The distance between the lens optical axis 101 and the lens optical axis 161 is also referred to as an “axis distance.” An angle of view of the camera device 100 is 0, and an angle of view of the TOF sensor 160 is φ.

In this way, the two optical axes are staggered, and therefore, if the distance to the subject existing in a ranging area of the TOF sensor 160 is different, the light reception device 165 among the plurality of light reception devices 165 of the TOF sensor 160 that measures the distance to the subject (i.e., the distance from the camera device 100 to the subject, also referred to as “subject distance”) is also different.

In FIG. 3, in order to simplify the description, a ranging area 1601 of the TOF sensor 160 is shown with 4×4 light reception devices 165 as an example. For example, when a distance to the subject is X₁, the light reception devices 165 corresponding to a third column from top to bottom within the ranging area 1601 measure the distance to the subject passing through the lens optical axis 101 of the camera device 100. A subject passing through the lens optical axis 101 refers to a subject on the lens optical axis 101, in other words, the lens optical axis 101 points to/passes through the subject. On the other hand, when a distance to the subject is X₂, the light reception devices 165 corresponding to a fourth column from top to bottom within the ranging area 1601 measure the distance to the subject passing through the lens optical axis 101 of the camera device 100. That is, if the distance to the subject passing through the lens optical axis 101 is different, the light reception devices 165 that measure the distance to the subject are also different.

Therefore, based on a plurality of distances Xₙ measured by the TOF sensor 160, a distance h between the lens optical axis 101 of the camera device 100 and the lens optical axis 161 of the TOF sensor 160, and the angle of view φ of the TOF sensor 160, the camera controller 110 can determine the distance to the subject passing through the lens optical axis 101 of the camera device 100 from the plurality of distances Xₙ. The camera device 100 may determine a width Hₙ in a direction of each of the plurality of distances Xₙ within the ranging area 1601 of the TOF sensor 160 from the lens optical axis 101 of the camera device 100 toward the lens optical axis 161 of the TOF sensor 160 based on each of the plurality of distances Xₙ, the distance h, and the angle of view φ. The above width is also referred to as a “ranging area width.” Then, the camera controller 110 may determine the distance to the subject passing through the lens optical axis 101 of the camera device 100 from the plurality of distances Xₙ based on a ratio h/He of each width Hₙ to the distance h.

Here, Hₙ satisfies Hₙ=2×Xₙ×tan(φ/2). For example, the TOF sensor 160 includes 4×4 light reception devices 165. In this case, when 0<h/Hₙ<¼ is satisfied, the light reception devices 165 corresponding to the third column from top to bottom within the ranging area 1601 measure the distance X₁ to the subject passing through the lens optical axis 101 of the camera device 100. On the other hand, when ¼<h/Hₙ<½ is satisfied, the light reception devices 165 corresponding to the fourth column from top to bottom within the ranging area 1601 measure the distance X₂ to the subject passing through the lens optical axis 101 of the camera device 100.

In this way, the camera controller 110 can determine the distance to the subject passing through the lens optical axis 101 of the camera device 100 from the plurality of distances Xₙ based on the plurality of distances Xₙ, the distance h, and the angle of view φ measured by the TOF sensor 160. Then, the camera controller 110 may perform the focus control of the camera device 100 based on the determined distance.

Here, if the distance to the subject is too short, depending on the angle of view of the TOF sensor 160, sometimes any one of the plurality of distances Xₙ measured by the TOF sensor 160 does not conform to the distance to the object passing through the lens optical axis 101 of the camera device 100. In this case, the distance to the subject cannot be measured by the TOF sensor 160. Therefore, when the camera controller 110 cannot determine the distance to the subject passing through the lens optical axis 101 of the camera device 100 from the plurality of distances Xₙ, it can perform the focus control of the camera device 100 based on a contrast evaluation value of the image. That is, when the camera controller 110 cannot determine the distance to the subject passing through the lens optical axis 101 of the camera device 100 from the plurality of distances Xₙ, it can perform a contrast autofocus.

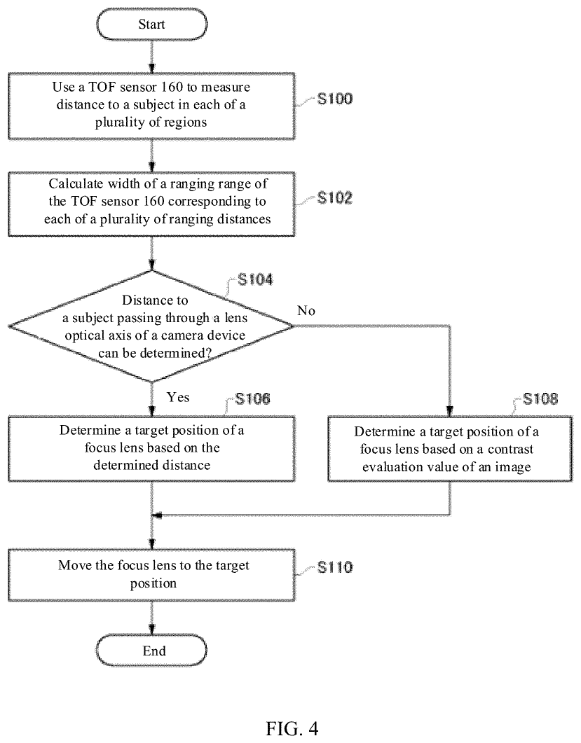

FIG. 4 is a flow chart showing an example of a focus control process of the camera controller 110.

The camera controller 110 causes the TOF sensor 160 to measure the distance to the subject in each of the plurality of regions (light reception devices 165) (S100). The camera controller 110 calculates the width Hₙ of the ranging area of the TOF sensor 160 corresponding to each of the plurality of ranging distances Xₙ according to Hₙ=2×Xₙ×tan(φ/2) (S102). The camera controller 110 determines whether the distance to the subject passing through the lens optical axis 101 of the camera device 100 can be determined from the plurality of distances Xₙ based on the width Hₙ and the distance h between the lens optical axis 101 and the lens optical axis 161 (S104).

When the distance to the subject passing through the lens optical axis 101 of the camera device 100 is determined, the camera controller 110 determines a target position of the focus lens for focusing on the subject based on the determined distance (S106). When the distance to the subject passing through the lens optical axis 101 of the camera device 100 cannot be determined, the camera controller 110 performs the contrast autofocus, and determines the target position of the focus lens for focusing on the subject based on the contrast evaluation value of the image (S108).

Next, the camera controller 110 moves the focus lens to the determined target position (S110).

As described above, according to the embodiments of the present disclosure, a region for measuring the distance of the subject passing through the lens optical axis 101 of the camera device 100 can be accurately determined within the plurality of regions of a ranging object of the TOF sensor 160. Therefore, the distance to the subject can be measured with high accuracy, and accuracy of the focus control based on a ranging result of the TOF sensor 160 can be improved.

Then, as a method of the focus control of the camera device 100, as a method for determining the distance to the subject, there is a method of moving the focus lens while determining based on a cost of a plurality of images taken at different states of positional relationship between the focus lens and the light reception surface of the image sensor 120, which is referred to as a Bokeh detection auto focus (BDAF) method herein.

For example, the cost (blur amount, amount of blur) of the image can be expressed by the following equation (1) using a Gaussian function. In equation (1), x represents a pixel position in a horizontal direction, and σ represents a standard deviation value.

$$C ( x , σ ) = \frac{1}{\sqrt{2 π}} exp ( - \frac{{x}^{2}}{2 {σ}^{2}} ) \qquad Equation ( 1 )$$

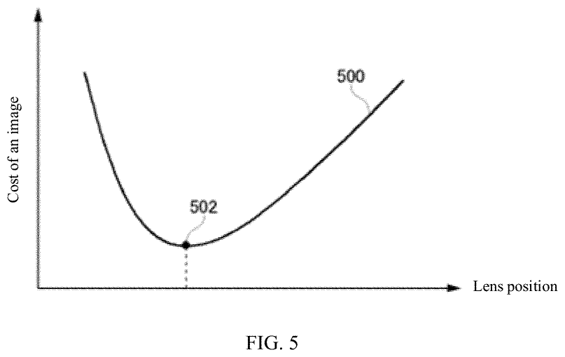

FIG. 5 shows an example of a curve 500 represented by equation (1). By aligning the focus lens to a lens position corresponding to a minimum point 502 of the curve 500, it can be focused on an object contained in the image.

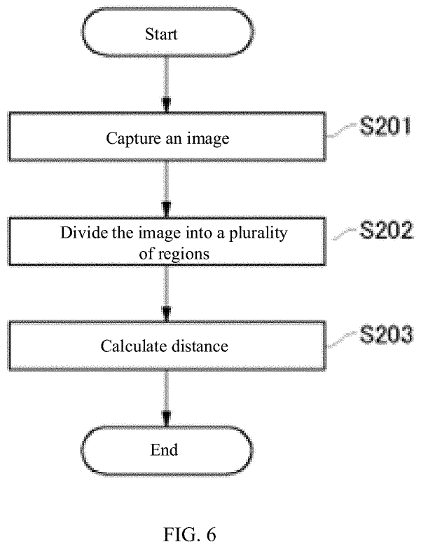

FIG. 6 is a flow chart showing an example of a distance calculation process of the BDAF method. First, in a state where the lens and an imaging surface are in a first positional relationship, the camera device 100 captures a first image I₁ and stores in the memory 130. Second, through movement of the focus lens or the imaging surface of the image sensor 120 along the optical axis direction, the lens and the imaging surface are in a second positional relationship, and the camera controller 110 uses the camera device 100 to capture a second image 12 and store in the memory 130 (S201). For example, as in a so-called hill-climbing autofocus, the focus lens or the imaging surface of the image sensor 120 is moved along the optical axis direction without exceeding the focus. A movement amount of the focus lens or the imaging surface of the image sensor 120 may be, for example, 10 μm.

Next, the camera controller 110 divides the image I₁ into a plurality of regions (S202). The camera controller 110 may calculate a feature amount according to each pixel in the image 12, and divide the image I₁ into a plurality of regions by taking a pixel group with similar feature amounts as one region. The camera controller 110 may also divide the pixel group set as a range of an autofocus processing frame in the image I₁ into a plurality of regions. The camera controller 110 divides the image I₂ into a plurality of regions corresponding to the plurality of regions of the image I₁. The camera controller 110 calculates the distance to the object included in each of the plurality of regions for each of the plurality of regions based on the respective costs of the plurality of regions of the image I₁ and the respective costs of the plurality of regions of the image I₂ (S203).

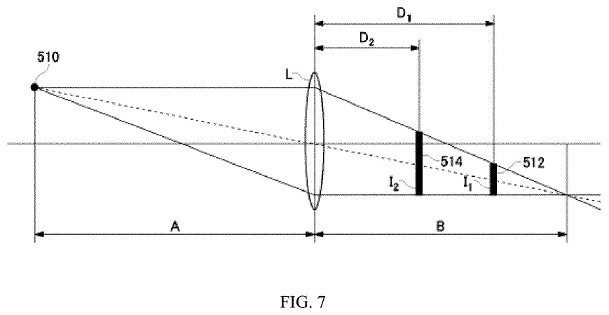

Distance calculation process is further explained with reference to FIG. 7. Distance from a lens L (principal point) to a subject 510 (object plane) is set to A, distance from the lens L (principal point) to an imaging position of the subject 510 on the imaging surface (image plane) is B, and a focal length is F. In this case, relationship of the distance A, the distance B, and the focal length F can be expressed by the following equation (2) according to lens formula.

$$\frac{1}{A} + \frac{1}{B} = \frac{1}{F} \qquad Equation ( 2 )$$

The focal length F is determined by the lens position. Therefore, if the distance B at which the subject 510 is imaged on the imaging surface can be determined, the distance A from the lens L to the subject 510 can be determined using equation (2).

As shown in FIG. 7, the distance B and then the distance A can be determined by calculating the imaging position of the subject 510 based on blur size (dispersion circles 512 and 514) of the subject 510 projected on the imaging surfaces. That is, the imaging position can be determined by combining the blur size (cost) in proportion to the imaging surface and the imaging position.

Distance from the image I₁ closer to the imaging surface to the lens L is set to D₁, and distance from the image I₂ farther from the imaging surface to the lens L is set to D₂. Each image is blurred. A point spread function is set to PSF, and images at D₁ and D₂ are set to I_{d1} and I_{d2}, respectively. In this case, for example, the image I₁ can be expressed by the following equation (3) according to a convolution operation.

I₁=PSF*I_{d1} Equation (3)

Further, a Fourier transform function of the image data I_{d1} and I_{d2} is set to f, and optical transfer functions after Fourier transform of the point spread functions PSF₁ and PSF₂ of the images Ica and I_{d2} are set to OTF₁ and OTF₂, a ratio of which is obtained by the following equation (4).

$$\frac{{OTF}_{2} \cdot f}{{OTF}_{1} \cdot f} = \frac{{OTF}_{2}}{{OTF}_{1}} = C \qquad Equation ( 4 )$$

The C value shown in equation (4) is an amount of change of respective costs of the images I_{d1} and I_{d2}, that is, the C value is equivalent to a difference between the cost of the image I_{d1} and the cost of the image I_{d2}.

Here, even if the distance is determined as described above, there is a possibility that an error may occur in the distance to the subject measured by the TOF sensor 160. Therefore, the camera controller 110 can combine the focus control based on the ranging of the TOF sensor 160 and the focus control using the BDAF method.

The camera controller 110 may determine the distance to the subject passing through the lens optical axis 101 of the camera device 100 from the plurality of distances Xₙ, and determine a first target position of the focus lens of the camera device 100 based on the distance. Further, the camera controller 110 may determine a second target position of the focus lens according to the costs of at least two images captured by the camera device 100 during the movement of the focus lens based on the first target position. That is, the camera controller 110 can perform the BDAF while moving the focus lens to the first target position, thereby accurately determining the target position of the focus lens for focusing the subject. Next, the camera controller 110 may perform the focus control by moving the focus lens to the second target position.

Here, the camera controller 110 needs at least two images with different costs when performing the focus control of the BDAF method. However, if the movement amount of the focus lens is small, difference in the costs between the two images is too small, and the camera controller 110 cannot accurately determine the target position.

Therefore, the camera controller 110 determines the distance to the subject passing through the lens optical axis 101 of the camera device 100 from the plurality of distances Xₙ, and determines the first target position of the focus lens of the camera device 100 based on the distance. Thereafter, the camera controller 110 determines the movement amount of the focus lens required to move the focus lens from the current position of the focus lens to the first target position. The camera controller 110 determines whether the movement amount is greater than or equal to a predetermined threshold that enables the BDAF to be performed.

If the movement amount is greater than or equal to the threshold, the camera controller 110 starts the focus lens to move to the first target position. On the other hand, when the movement amount is less than the threshold, the camera controller 110 first moves the focus lens in a direction away from the first target position, and then moves the focus lens in an opposite direction toward the first target position so that the movement amount of the focus lens is greater than or equal to the threshold. Therefore, the camera controller 110 can perform the BDAF while moving the focus lens to the first target position, and perform more accurate focus control.

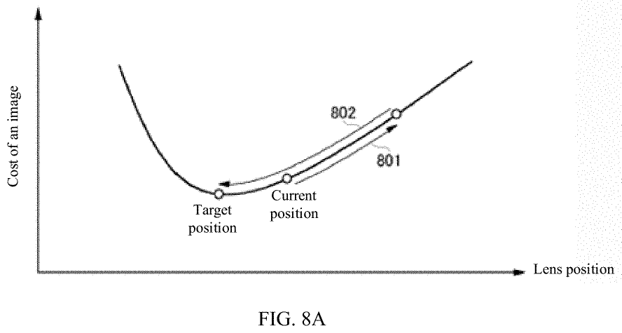

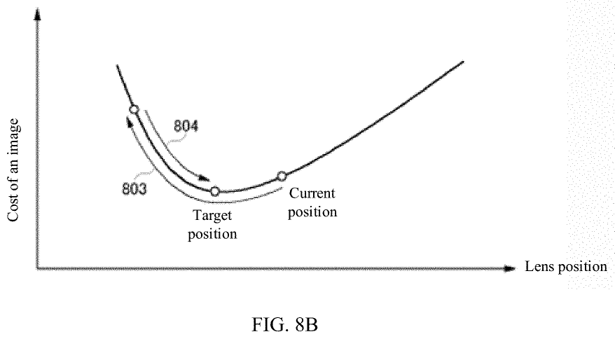

As shown in FIG. 8A, the camera controller 110 first moves the focus lens in a direction 801 opposite to the direction toward the first target position, and then moves the focus lens in a direction 802 toward the first target position so that the movement amount of the focus lens can be greater than or equal to the threshold. Or as shown in FIG. 8B, the camera controller 110 begins moving in a direction 803 toward the first target position, and once the focus lens is moved beyond the first target position, the focus lens is moved toward the first target position while in an opposite direction 804 so that the movement amount of the focus lens can be greater than or equal to the threshold.

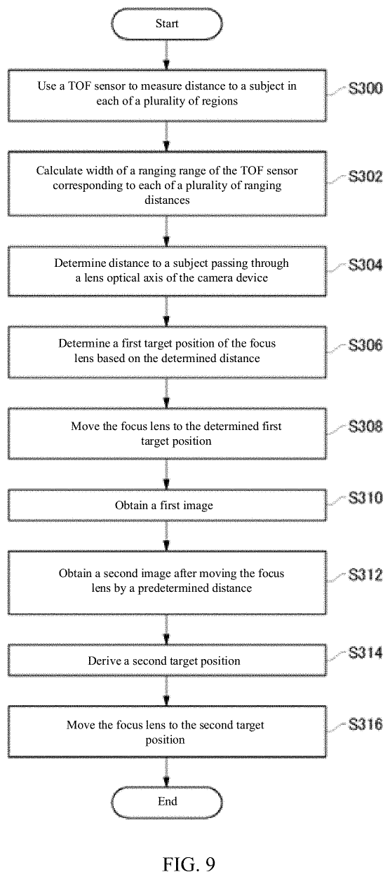

FIG. 9 is a flow chart showing another example of the focus control process of the camera controller 110.

The camera controller 110 causes the TOF sensor 160 to measure the distance to the subject in each of the plurality of regions (light reception devices 165) (S300). The camera controller 110 calculates the width Hₙ of the ranging area of the TOF sensor 160 corresponding to each of the plurality of ranging distances Xₙ according to Hₙ=2×Xₙ×tan(φ/2) (S302). The camera controller 110 determines the distance to the subject passing through the lens optical axis 101 of the camera device 100 from the plurality of distances Xₙ based on the width Hₙ and the distance h between the lens optical axis 101 and the lens optical axis 161 (S304).

The camera device 110 determines the first target position of the focus lens for focusing the subject based on the determined distance (S306). Next, the camera controller 110 moves the focus lens to the determined first target position (S308).

The camera controller 110 obtains a first image captured by the camera device 100 during the movement of the focus lens to the first target position (S310). Next, after moving the focus lens by a predetermined distance, the camera controller 110 obtains a second image captured by the camera device 100 (S312). The camera controller 110 derives the second target position of the focus lens by the BDAF method based on costs of the first image and the second image (S314). The camera controller 110 corrects the target position of the focus lens from the first target position to the second target position, and moves the focus lens to the target position (S316).

As described above, according to the embodiments of the present disclosure, even when the distance measured by the TOF sensor 160 includes an error, the target position of the focus lens can be corrected by performing the BDAF, so that a desired subject can be accurately focused. Also, according to the target position based on the distance measured by the TOF sensor 160, the camera controller 110 can correctly determine a direction in which the focus lens begins to move. That is, the camera controller 110 can prevent focus control time from becoming longer or power consumption from increasing due to meaningless movement of the focus lens in an opposite direction.

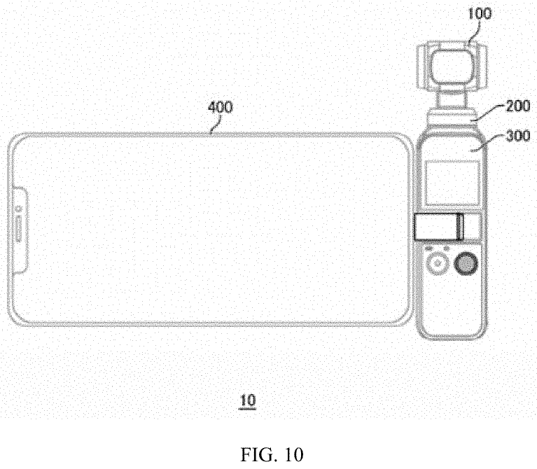

An example of an external perspective view showing another aspect of the camera system 10 is shown in FIG. 10. The camera system 10 can be used in a state where a mobile terminal including a display such as a smart phone 400 is secured to a side of the holding member 300.

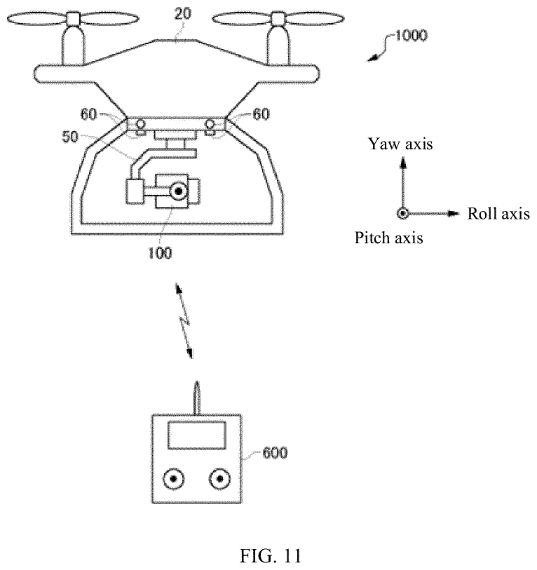

The camera device 100 described above may be mounted at a movable object. The camera device 100 may also be mounted at an unmanned aerial vehicle (UAV) as shown in FIG. 11. The UAV 1000 may include a UAV body 20, a gimbal 50, a plurality of camera devices 60, and a camera device 100. The gimbal 50 and the camera device 100 are an example of a camera system. UAV 1000 is an example of the movable object propelled by a propulsion unit. The concept of the movable object refers to a flight object such as an aerial vehicle movable in the air, a vehicle movable on the ground, a ship movable on water, etc., in addition to the UAV.

The UAV body 20 includes a plurality of rotors which are an example of the propulsion unit. The UAV body 20 causes the UAV 1000 to fly by controlling the rotation of the plurality of rotors. The UAV body 20 uses, for example, four rotors to cause the UAV 1000 to fly. Number of rotors is not limited to four, and UAV 1000 can also be a fixed-wing aircraft without rotors.

The camera device 100 is an imaging camera for photographing a subject within a desired imaging range. The gimbal 50 rotatably supports the camera device 100. The gimbal 50 is an example of a support mechanism. For example, the gimbal 50 supports the camera device 100 so that it can be rotated with a pitch axis using an actuator. The gimbal 50 supports the camera device 100 so that it can also be rotated around a roll axis and a yaw axis respectively using the actuator. The gimbal 50 can change attitude of the camera device 100 by rotating the camera device 100 around at least one of the yaw axis, the pitch axis, or the roll axis.

The plurality of camera devices 60 are sensing cameras for photographing the surroundings of the UAV 1000 in order to control flight of the UAV 1000. Two camera devices 60 can be arranged on nose of the UAV 1000, i.e., on front side. Also, other two camera devices 60 may be arranged on bottom side of the UAV 1000. The two camera devices 60 on the front side may be paired to function as a so-called stereo camera. The two camera devices 60 on the bottom side may also be paired to function as a stereo camera. Three-dimensional spatial data around the UAV 1000 can be generated based on images captured by the plurality of camera devices 60. Number of camera devices 60 included in the UAV 1000 is not limited to four. The UAV 1000 is provided with at least one camera device 60. The UAV 1000 may also be provided with at least one camera 60 on the nose, tail, side, bottom, and top surface of the UAV 1000, respectively. A viewing angle that can be set in the camera device 60 may be larger than the viewing angle that can be set in the camera device 100. The camera device 60 may also have a single focus lens or a fisheye lens.

A remote operation device 600 communicates with the UAV 1000 to remotely operate the UAV 1000. The remote operation device 600 can wirelessly communicate with the UAV 1000. The remote operation device 600 sends to the UAV 1000 instruction information indicating various instructions related to the movement of the UAV 1000 such as rise, fall, acceleration, deceleration, forward, backward, rotation, etc. The instruction information includes, for example, instruction information for raising altitude of the UAV 1000. The instruction information may indicate an altitude at which the UAV 1000 should be located. The UAV 1000 moves to be located at the altitude indicated by the instruction information received from the remote operation device 600. The instruction information may include a rise instruction to raise the UAV 1000. UAV 1000 rises during the period while receiving the rise instruction. When the altitude of UAV 1000 has reached an upper limit, the rise of the UAV 1000 can be restricted even if the rise instruction is received.

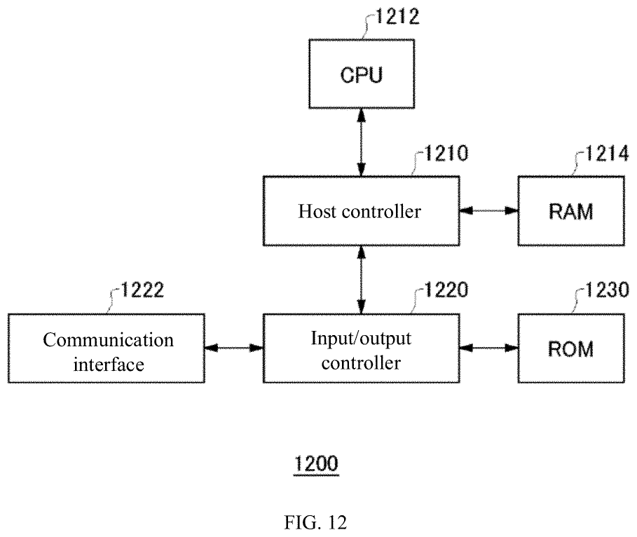

FIG. 12 shows an example of a computer 1200 that can fully or partially embody various aspects of the present disclosure. A program installed on the computer 1200 can make the computer 1200 function as an operation associated with a device or one or more “units” of the device involved in some embodiments of the present disclosure. Or, the program can enable the computer 1200 to perform the operation or the one or more “units.” The program can enable the computer 1200 to execute processes or stages of the processes involved in some embodiments of the present disclosure. Such a program may be executed by a CPU 1212, so that the computer 1200 performs specified operations associated with some or all of the blocks in the flowcharts and block diagrams described in this specification.

The computer 1200 according to the present disclosure includes the CPU 1212 and a RAM 1214, which are connected to each other through a host controller 1210. The computer 1200 also includes a communication interface 1222 and an input/output unit, which are connected to the host controller 1210 through an input/output controller 1220. The computer 1200 also includes a ROM 1230. The CPU 1212 works in accordance with programs stored in the ROM 1230 and RAM 1214 to control each unit.

The communication interface 1222 communicates with other electronic devices via a network. A hard disk drive can store programs and data used by the CPU 1212 in the computer 1200. The ROM 1230 stores therein a boot program executed by the computer 1200 during operation, and/or a program dependent on hardware of the computer 1200. The program is provided by network or a computer readable recording medium such as a CR-ROM, a USB memory, or an IC card. The program is installed in the RAM 1214 or ROM 1230 which is also an example of the computer readable recording medium and is executed by the CPU 1212. Information processing described in these programs is read by the computer 1200 and causes cooperation between the programs and various types of hardware resources described above. The information operation or processing can be implemented according to use of the computer 1200, thereby constituting a device or method.

For example, when the computer 1200 is performing communication with an external device, the CPU 1212 may execute a communication program loaded in the RAM 1214, and instruct the communication interface 1222 to perform communication processing based on the processing described in the communication program. Under the control of the CPU 1212, the communication interface 1222 reads transmission data stored in a transmission buffer provided in a recording medium such as the RAM 1214 or USB memory, and sends the read transmission data to the network, or writes the received data from the network into a receiving buffer provided in the recording medium, etc.

In addition, the CPU 1212 can make the RAM 1214 read all or necessary parts of a file or database stored in an external recording medium such as a USB memory, and perform various types of processing on data in the RAM 1214. Then, the CPU 1212 can write the processed data back into the external recording medium.

Various types of information, such as various types of programs, data, tables, and databases, can be stored in the recording medium and subjected to information processing. For data read from the RAM 1214, the CPU 1212 can perform various types of operations, information processing, conditional judgment, conditional transfer, unconditional transfer, or information retrieval/replacement specified by the instruction sequence of the program described in various places in this disclosure, and write the results back into the RAM 1214. In addition, the CPU 1212 can retrieve information in files, databases, etc. in the recording medium. For example, when multiple entries having attribute values of a first attribute respectively associated with the attribute values of a second attribute are stored in the recording medium, the CPU 1212 can retrieve an entry that matches condition of the attribute value of specified first attribute from the multiple entries, and read the attribute value of the second attribute stored in the entry, so as to obtain the attribute value of the second attribute associated with the first attribute that satisfies a predetermined condition.

The programs or software modules described above may be stored on the computer 1200 or the computer readable storage medium near the computer 1200. In addition, the recording medium such as a hard disk or RAM provided in a server system connected to a dedicated communication network or Internet can be used as the computer readable storage medium so that the program can be provided to the computer 1200 via the network.

The present disclosure has been described through some embodiments, but the technical scope of the present disclosure is not limited to the described embodiments. It is obvious to those of ordinary skill in the art that various changes or improvements can be made to the embodiments described above. It is obvious from the description of the claims that all such changes or improvements can be included within the technical scope of the present disclosure.

It should be noted that the execution order of various processes, such as actions, sequences, steps, and stages of the devices, systems, programs, and methods in the claims, specification, and drawings, can be implemented in any order, as long as there is no special indication of “before,” “in advance,” etc., and as long as an output of a previous processing is not used in the subsequent processing. Regarding the operating procedures in the claims, specification, and drawings, the description is made using “first,” “next,” etc. for convenience, but it does not mean that it must be implemented in such an order.

Reference numerals: camera system 10; UAV body 20; gimbal 50; camera device 60; camera device 100; lens optical axis 101; camera controller 110; image sensor 120; memory 130; lens controller 150; lens driver 152; lens 154; TOF sensor 160; lens optical axis 161; light emitter 162; light emission device 163; light receiver 164; light reception device 165; light emission controller 166; light reception controller 167; memory 168; support mechanism 200; roll axis driver 201; pitch axis driver 202; yaw axis driver 203; base 204; attitude controller 210; angular velocity sensor 212; acceleration sensor 214; holding member 300; operation interface 301; display 302; smart phone 400; remote operation device 600; computer 1200; host controller 1210; CPU 1212; RAM 1214; input/output controller 1220; communication interface 1222; ROM 1230.

What is claimed is:

1. A control device comprising:
a circuit configured to determine, from a plurality of measured distances measured by a ranging sensor of a camera device, a subject distance from the camera device to a subject on a lens optical axis of the camera device based on:
the plurality of measured distances,
an axis distance between the lens optical axis of the camera device and a lens optical axis of the ranging sensor, and
an angle of view of the ranging sensor.

2. The control device of claim 1, wherein the circuit is further configured to:
for each measured distance of the plurality of measured distances, determine a ranging area width of a ranging area of the ranging sensor corresponding to the of measured distance in a direction from the lens optical axis of the camera device toward the lens optical axis of the ranging sensor, based on the measured distance, the axis distance, and the angle of view; and
determine the subject distance from the plurality of measured distances based on a plurality of ratios each being a ratio of one of the ranging area widths to the axis distance.

3. The control device of claim 1, wherein the circuit is further configured to perform a focus control of the camera device based on the subject distance.

4. The control device of claim 1, wherein the circuit is further configured to perform a focus control of the camera device based on a contrast evaluation value of an image captured by the camera device in response to failing to determine the subject distance from the plurality of measured distances.

5. The control device of claim 1, wherein the circuit is further configured to:
determine a first target position of a focus lens of the camera device based on the axis distance;
during a process of moving the focus lens based on the first target position, determine a second target position of the focus lens based on costs of at least two images captured by the camera device; and
move the focus lens to the second target position.

6. A camera device comprising:
a ranging sensor including a first image sensor configured to perform distance measurement in a plurality of regions;
a second image sensor configured to shoot a subject on a lens optical axis of the camera device; and
a control device including a circuit configured to determine, from a plurality of measured distances measured by the ranging sensor, a subject distance from the camera device to the subject based on:
the plurality of measured distances,
an axis distance between the lens optical axis of the camera device and a lens optical axis of the ranging sensor, and
an angle of view of the ranging sensor.

7. The camera device of claim 6, wherein the circuit is further configured to:
for each measured distance of the plurality of measured distances, determine a ranging area width of a ranging area of the ranging sensor corresponding to the of measured distance in a direction from the lens optical axis of the camera device toward the lens optical axis of the ranging sensor, based on the measured distance, the axis distance, and the angle of view; and
determine the subject distance from the plurality of measured distances based on a plurality of ratios each being a ratio of one of the ranging area widths to the axis distance.

8. The camera device of claim 6, wherein the circuit is further configured to perform a focus control of the camera device based on the subject distance.

9. The camera device of claim 6, wherein the circuit is further configured to perform a focus control of the camera device based on a contrast evaluation value of an image captured by the camera device in response to failing to determine the subject distance from the plurality of measured distances.

10. The camera device of claim 6, wherein the circuit is further configured to:
determine a first target position of a focus lens of the camera device based on the axis distance;
during a process of moving the focus lens based on the first target position, determine a second target position of the focus lens based on costs of at least two images captured by the camera device; and
move the focus lens to the second target position.

11. A movable object comprising the camera device of claim 6.

12. The movable object of claim 11, wherein the circuit is further configured to:
for each measured distance of the plurality of measured distances, determine a ranging area width of a ranging area of the ranging sensor corresponding to the of measured distance in a direction from the lens optical axis of the camera device toward the lens optical axis of the ranging sensor, based on the measured distance, the axis distance, and the angle of view; and
determine the subject distance from the plurality of measured distances based on a plurality of ratios each being a ratio of one of the ranging area widths to the axis distance.

13. The movable object of claim 11, wherein the circuit is further configured to perform a focus control of the camera device based on the subject distance.

14. The movable object of claim 11, wherein the circuit is further configured to perform a focus control of the camera device based on a contrast evaluation value of an image captured by the camera device in response to failing to determine the subject distance from the plurality of measured distances.

15. The movable object of claim 11, wherein the circuit is further configured to:
determine a first target position of a focus lens of the camera device based on the axis distance;
during a process of moving the focus lens based on the first target position, determine a second target position of the focus lens based on costs of at least two images captured by the camera device; and
move the focus lens to the second target position.

16. A control method comprising:
determining, from a plurality of measured distances measured by a ranging sensor of a camera device, a subject distance from the camera device to a subject on a lens optical axis of the camera device based on:
the plurality of measured distances,
an axis distance between the lens optical axis of the camera device and a lens optical axis of the ranging sensor, and
an angle of view of the ranging sensor.

17. The control method of claim 16, wherein determining the subject distance from the plurality of measured distances includes:
for each measured distance of the plurality of measured distances, determining a ranging area width of a ranging area of the ranging sensor corresponding to the of measured distance in a direction from the lens optical axis of the camera device toward the lens optical axis of the ranging sensor, based on the measured distance, the axis distance, and the angle of view; and
determining the subject distance from the plurality of measured distances based on a plurality of ratios each being a ratio of one of the ranging area widths to the axis distance.

18. The control method of claim 16, further comprising:
performing a focus control of the camera device based on the subject distance.

19. The control method of claim 16, further comprising:
performing a focus control of the camera device based on a contrast evaluation value of an image captured by the camera device in response to failing to determine the subject distance from the plurality of measured distances.

20. The control method of claim 16, further comprising:
determining a first target position of a focus lens of the camera device based on the axis distance;
during a process of moving the focus lens based on the first target position, determining a second target position of the focus lens based on costs of at least two images captured by the camera device; and
moving the focus lens to the second target position.
